(19) United States
(12) Patent Application Publication
(10) Pub. No.: US 2014/0191853 A1
(43) Pub. Date: Jul. 10, 2014

(54) POWER CONTROL SYSTEM

(71) Applicant: Wistron Corporation, New Taipei City (TW)

(72) Inventor: Jian-Ming Chen, New Taipei City (TW)

(73) Assignee: Wistron Corporation, New Taipei City (TW)

(21) Appl. No.: 13/954,010

(22) Filed: Jul. 30, 2013

(30) Foreign Application Priority Data
Jan. 8, 2013 (TW) 102100557

(51) Int. Cl. G08C 17/02

(52) U.S. Cl. CPC G08C 17/02
USPC 340/12.5

(57) ABSTRACT

A power control system includes an electronic device including a relay connected to a mains supply, a control circuit connected to the relay, and a receptive circuit connected to the control circuit, and a remote control device including a transmission circuit for transmitting a triggering signal to the receptive circuit. Upon receipt of the triggering signal from the receptive circuit, the control circuit generates, based on the triggering signal, a driving voltage sufficient for switching the relay from an off state to an on state to permit supply of electricity from the mains supply to the electronic device for driving operation thereof.

### CROSS-REFERENCE TO RELATED APPLICATION

This application claims priority of Taiwanese Patent Application No. 102100557, filed on Jan. 8, 2013.

### BACKGROUND OF THE INVENTION

1. Field of the Invention

This invention relates to a power control system, more particularly a power control system that enables complete power interruption.

2. Description of the Related Art

Since resources on the Earth are becoming scarce, energy saving appliances are strictly regulated. As far as a flat panel television is concerned, a standby mode voltage thereof is regulated at 1 Watt/hr or less. A conventional display device 900 shown in FIG. 1 includes a power board 910 that processes AC/DC conversion and a main board 920 that controls operation of the display device 900. To turn off the conventional display device 900, a power button of a remote controller (not shown) is pressed so that the display device 900 enters the standby mode, where a switch circuit 921 of the main board 920 is turned off to isolate the main board 920 from the direct current (DC) voltage generated by the power board 910 in order to lower power consumption.

However, even if the display device 900 enters the standby mode, the power board 910 still receives alternate current (AC) voltage, and the conventional display device 900 still consumes a certain amount of power, unless a power plug of the display device 900 is removed from mains supply 3, which is rather inconvenient.

### SUMMARY OF THE INVENTION

Therefore, an object of the present invention is to provide a power control system that a control circuit is capable of switching a relay between different states.

Accordingly, a power control system of this invention includes an electronic device and a remote control device.

The electronic device includes a relay that is adapted to be electrically connected to a mains supply, a control circuit that is electrically connected to the relay, and a receptive circuit that is electrically connected to the control circuit. The control circuit is capable of generating a driving voltage that is sufficient for switching the relay from an off state to an on state, such that the relay permits supply of electricity from the mains supply to the electronic device for driving operation thereof.

The remote control device includes a transmission circuit that is capable of establishing a connection with the receptive circuit of the electronic device. The remote control device is operable to transmit via the transmission circuit a triggering signal to the receptive circuit. Upon receipt of the triggering signal via the receptive circuit, the control circuit generates the driving voltage based on the triggering signal.

Another object of the present invention is to provide a power control system that enables a power interruption mode where an electronic device is electrically isolated from a mains supply without removing a power plug of the electronic device from the mains supply.

Accordingly, a power control system of this invention includes an electronic device and a remote control device.

The electronic device includes a relay that is adapted to be electrically connected to a mains supply, a control circuit that is electrically connected to the relay, and a receptive circuit that is electrically connected to the control circuit.

The remote control device includes a transmission circuit that is capable of establishing a connection with the receptive circuit. The remote control device is operable to transmit via the transmission circuit an electrical signal to the receptive circuit.

Upon receipt of the electrical signal from the receptive circuit, the control circuit generates a driving voltage based on the electrical signal to control the relay to switch between off and on states so as to switch the electronic device between a power interruption mode, where the electronic device is electrically isolated from the mains supply by the relay, and an operation mode, where the electronic device is adapted to be electrically connected to the mains supply through the relay.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a block diagram of a conventional display device;

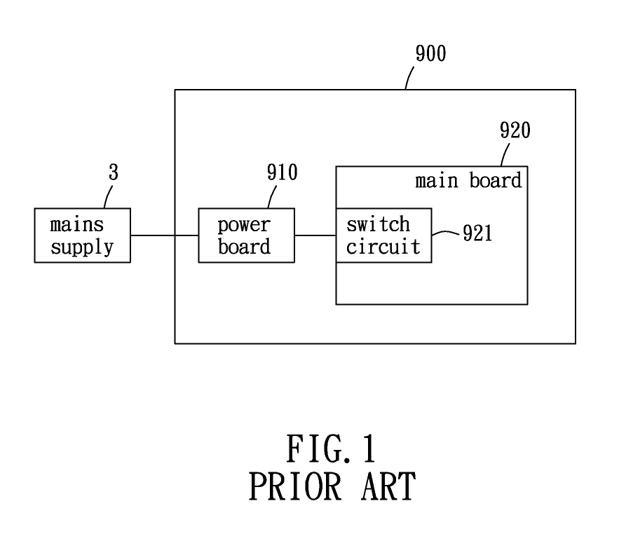

FIG. 2 is a block diagram of a power control system according to a first preferred embodiment of this invention;

FIG. 3 is a block diagram a power control system according to a second preferred embodiment of this invention; and

FIG. 4 is a block diagram a power control system according to a third preferred embodiment of this invention.

### DETAILED DESCRIPTION OF THE PREFERRED EMBODIMENTS

Before the present invention is described in greater detail, it should be noted herein that like elements are denoted by the same reference numerals throughout the disclosure.

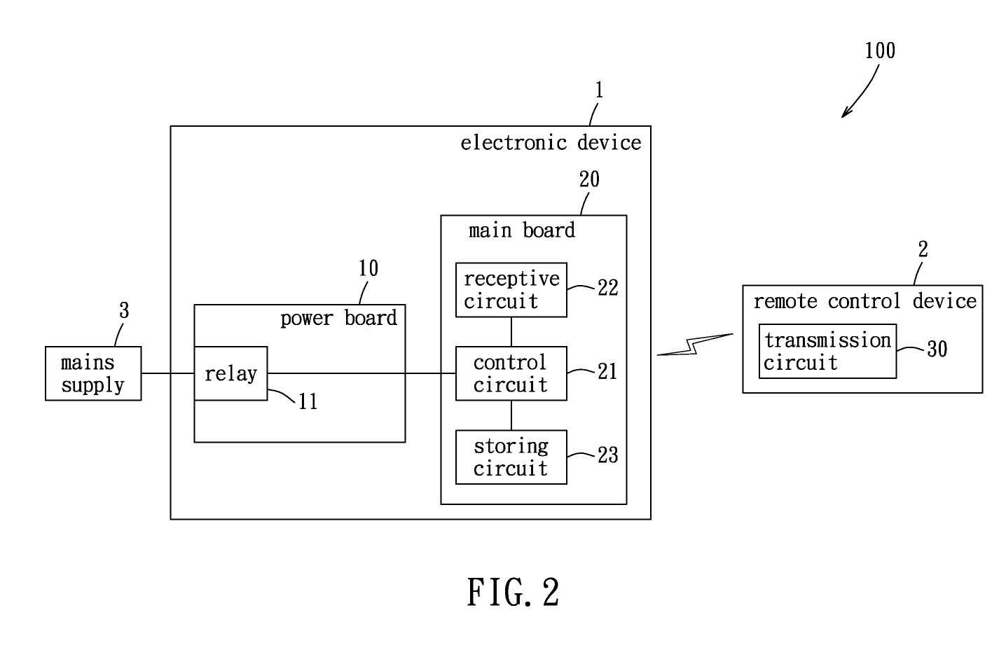

Referring to FIG. 2, a power control system 100 according to the first preferred embodiment of this invention includes an electronic device 1 and a remote control device 2.

The electronic device 1 in this embodiment is exemplified as a flat panel television, and includes a power board 10 for performing A/D (alternating current/direct current) conversion, and a main board 20 for controlling operation of the electronic device 1. The power board 10 is provided with a relay 11, which is exemplified as a photo relay in this embodiment and is adapted to be electrically connected to a mains supply 3 for receiving AC electricity therefrom. The mains supply 3 in this embodiment has a voltage ranging from 100 Volts to 204 Volts. It is noted that the relay 11 may also be an electromagnetic relay, a sensory relay, an electromechanical relay, an electronic relay, a thermal relay, or any switch capable of controlling a large current conduction with a small current. Moreover, the electronic device 1 may as well be a computer monitor, a tablet computer, etc.

The main board 20 is provided with a control circuit 21, a receptive circuit 22 and a storing circuit 23. The control circuit 21 is a microcontroller unit (MCU) and is electrically connected to the relay 11, and is capable of switching the relay 11 between on and off states. The receptive circuit 22 is electrically connected to the control circuit 21. The storing circuit 23 is electrically connected to the control circuit 21, and records a current state of the relay 11. The storing circuit 23 is exemplarily implemented by a flag register for storing a flag that presents the current state (on or off) of the relay 11, or may otherwise be a memory.

The remote control device 2 is exemplified as a television remote controller and includes a transmission circuit 30 that is capable of establishing a connection with the receptive circuit 22 of the electronic device 1. The transmission circuit 30 establishes the connection with the receptive circuit 22 using for example, Radio frequency identification (RFID), Wireless Fidelity (Wi-Fi) or Bluetooth. In this embodiment, the transmission circuit 30 and the receptive circuit 22 are respectively is an RFID transmitter and an RFID receptor, but are not limited thereto.

When a user presses a control key (not shown) on the remote control device 2, the remote control device 2 operates to transmit via the transmission circuit 30 a triggering signal (an electrical signal) to the receptive circuit 22. The control circuit 21 generates a driving voltage upon receipt of the triggering signal via the receptive circuit 22. The control circuit 21 generates the driving voltage based on the triggering signal (e.g., through conversion) and with reference to the current state of the relay 11 as recorded in the storing circuit 23. If the current state of the relay 11 is off, the control circuit 21 generates the driving voltage that is sufficient for switching the relay 11 from the off state to the on state, so that the relay 11 permits supply of electricity from the mains supply 3 to the electronic device 1 for driving operation thereof. If the current state of the relay 11 is on, the control circuit 21 generates the driving voltage that is sufficient for switching the relay 11 from the on state to the off state, such that the relay 11 prevents supply of the electricity from the mains supply 3 to the electronic device 1 for ceasing operation thereof. As the relay 11 switches between the on and off states, the electronic device 1 switches between an operation mode and a power interruption mode. Under the operation mode, the electronic device 1 receives electricity from the mains supply 3 through the relay 11. Under the power interruption mode, the electronic device 1 is electrically isolated by the relay 11 and consumes no electricity from the mains supply 3, thereby not only making power consumption of the electronic device 1 under 1 Watt/hr in conformance with international regulation, but also making the power consumption as minimal as possible.

Moreover, when transmitting the driving voltage to switch the on/off state of the relay 11, the control circuit 21 simultaneously and correspondingly updates a value of the flag recorded in the storing circuit 23. A value of 0 is assigned to the flag to indicate the off state of the relay 11, and a value of 1 is assigned to the flag to indicate the on state of the relay 11.

The electronic device 1 further includes a power board 10 and a main board 20. The power board 10 is provided with the relay 11 for processing (AC/DC) (alternating current/direct current) conversion.

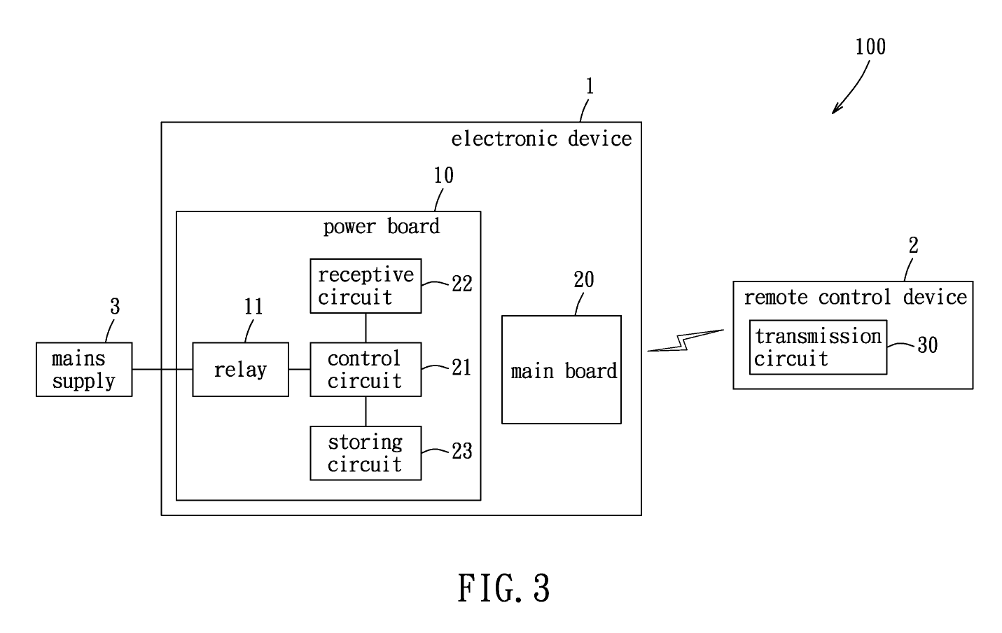

Referring to FIG. 3, a power control system according to the second preferred embodiment of this invention is similar to that of the first preferred embodiment except that in addition to the relay 11, the control circuit 21, the receptive circuit 22 and the storing circuit 23 are all provided on the power board 10. Through this arrangement, the same effects as mentioned above in the first preferred embodiment are also achieved.

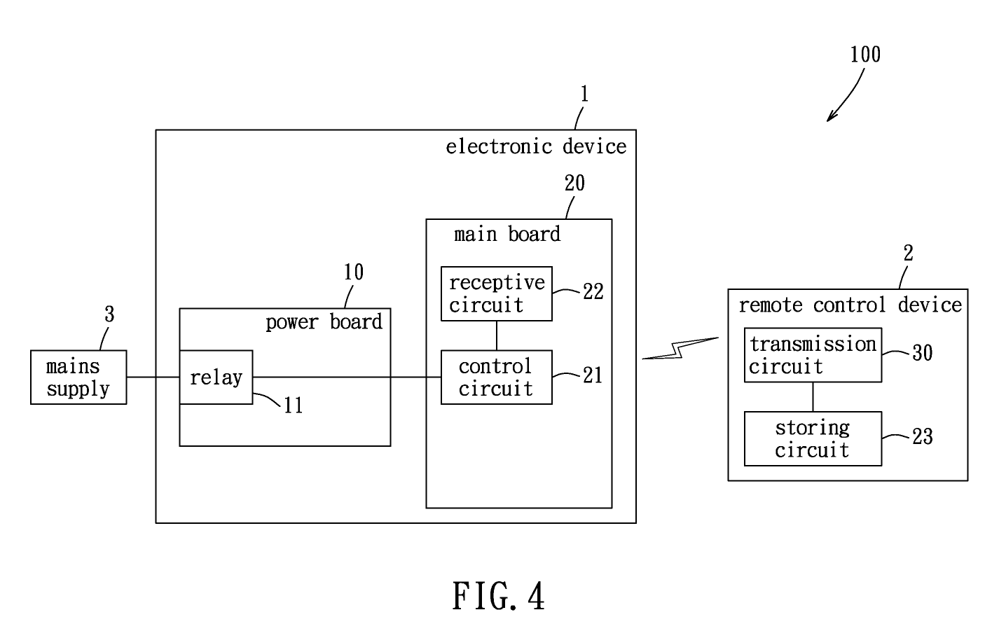

Referring to FIG. 4, a power control system according to the third preferred embodiment of this invention is similar to that of the first preferred embodiment except that, rather than on the electronic device 1, the storing circuit 23 is provided on the remote control device 2.

When triggered, the transmission circuit 30 transmits the triggering signal along with the value of the flag, or the current state of the relay 11 as recorded in the storing circuit 23, to the receptive circuit 22 of the electronic device 1 so that the control circuit 21 can directly determine the current state of the relay 11 based on the flag and generate the driving voltage accordingly. Similarly, the same effects as mentioned above in the first preferred embodiment are also achieved through this arrangement.

To sum up, the electronic device 1 operating under a power interruption mode, is isolated from the mains supply 3 so as not to consume any power. In addition, the control circuit 21 of the electronic device 1 is capable of generating, when the electronic device 1 is in the power interruption mode, the driving voltage from an electrical signal, which is transmitted by the remote control device 2, sufficient to switch the relay 11 on, in order to switch the electronic device 1 to an operation mode.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

What is claimed is:

1. A power control system, comprising:
an electronic device including a relay that is adapted to be electrically connected to a mains supply, a control circuit that is electrically connected to said relay, and a receptive circuit that is electrically connected to said control circuit, wherein said control circuit is capable of generating a driving voltage that is sufficient for switching said relay from an off state to an on state, such that said relay permits supply of electricity from the mains supply to said electronic device for driving operation thereof; and
a remote control device including a transmission circuit that is capable of establishing a connection with said receptive circuit of said electronic device, said remote control device being operable to transmit via said transmission circuit a triggering signal to said receptive circuit;
wherein upon receipt of the triggering signal via said receptive circuit, said control circuit generates the driving voltage based on the triggering signal.

2. The power control system of claim 1, wherein said relay is one of a photo relay, an electromagnetic relay, a sensory relay, an electromechanical relay, an electronic relay and a thermal relay.

3. The power control system of claim 1, wherein the driving voltage generated by said control circuit is further sufficient for switching said relay from the on state to the off state, such that said relay prevents supply of the electricity from the mains supply to said electronic device for ceasing operation thereof.

4. The power control system of claim 1, wherein said electronic device further includes a storing circuit that is electrically connected to said control circuit, and that records a current state of said relay.

5. The power control system of claim 4, wherein said electronic device further includes a power board that is provided with said relay, and a main board that is provided with said control circuit, said receptive circuit and said storing circuit.

6. The power control system of claim 1, wherein said electronic device further includes a power board that is provided with said relay, said control circuit and said receptive circuit.

7. The power control system of claim 1, wherein said remote control device further includes a storing circuit for recording a current state of said relay, said remote control device transmitting via said transmission circuit both the triggering signal and the current state of said relay to said receptive circuit.

8. The power control system of claim 1, wherein said transmission circuit establishes the connection with said receptive circuit using one of Radio frequency identification (RFID), Wireless fidelity (Wi-Fi) and Bluetooth.

9. A power control system, comprising:
an electronic device including a relay that is adapted to be electrically connected to a mains supply, a control circuit that is electrically connected to said relay, and a receptive circuit that is electrically connected to said control circuit; and
a remote control device including a transmission circuit that is capable of establishing a connection with said receptive circuit, said remote control device being operable to transmit via said transmission circuit an electrical signal to said receptive circuit;
wherein upon receipt of the electrical signal from said receptive circuit, said control circuit generates a driving voltage based on the electrical signal to control said relay to switch between off and on states so as to switch said electronic device between a power interruption mode, where said electronic device is electrically isolated from the mains supply by said relay, and an operation mode, where said electronic device receives electricity from the mains supply through said relay.

10. The power control system of claim 9, wherein said electronic device further includes a storing circuit that is electrically connected to said control circuit, and that records a current state of said relay.

11. The power control system of claim 10, wherein said electronic device further includes a power board that is provided with said relay, and a main board that is provided with said control circuit, said receptive circuit and said storing circuit.

12. The power control system of claim 9, wherein said electronic device further includes a power board that is provided with said relay, said control circuit and said receptive circuit.

13. The power control system of claim 9, wherein said remote control device further includes a storing circuit for recording a current state of said relay, said remote control device transmitting via said transmission circuit both the triggering signal and the current state of said relay to said receptive circuit.

14. The power control system of claim 9, wherein said transmission circuit transmits the electrical signal using one of Radio frequency identification (RFID), Wireless fidelity (Wi-Fi) and Bluetooth.

15. The power control system of claim 9, wherein said relay is one of a photo relay, an electromagnetic relay, a sensory relay, an electromechanical relay, an electronic relay and a thermal relay.
